(19) United States
(12) Patent Application Publication
(10) Pub. No.: US 2012/0305509 A1
(43) Pub. Date: Dec. 6, 2012

(54) RETAINING DEVICE FOR CHILD PLAY AND CARE ITEMS

(76) Inventor: Alice K. Benson, Camas, WA (US)

(21) Appl. No.: 13/483,818

(22) Filed: May 30, 2012

Related U.S. Application Data
(60) Provisional application No. 61/491,666, filed on May 31, 2011.

(51) Int. Cl. F16B 47/00; F16M 13/02

(52) U.S. Cl. 211/85.7; 248/206.2

(57) ABSTRACT

The present invention relates to a retaining device for mounting a toy mounting assembly to a surface, such as a table top or highchair tray, wherein the toy mounting assembly further comprises adjustable tethering straps which can be attached to toys or any childcare item used by an infant or toddler. The toy mounting assembly comprises a suction cup base mounted thereto.

### CROSS-REFERENCE TO RELATED APPLICATIONS

This application claims priority under 35 U.S.C. §119(e) and the benefit of U.S. Provisional Application No. 61/491,666 entitled RETAINING DEVICE FOR CHILD PLAY AND CARE ITEMS, filed on May 31, 2011, by Alice K. Benson, the entire disclosure of which is incorporated herein by reference.

### BACKGROUND OF THE INVENTION

The present invention relates to a retaining device, and more specifically, to a retaining device for securing a childcare item to a toy mounting assembly to keep the secured childcare item or toy tethered and in reach of a user while also preventing the childcare item from falling and landing on a floor or other surface.

### SUMMARY OF THE INVENTION

One aspect of the present invention includes a retaining device for tethering a childcare item comprising a toy mounting assembly including a toy item having front side, back side, top side and bottom side, and an aperture disposed on the bottom side, which opens into a cavity disposed in an interior of the toy item. A suction cup base having a top planar portion and a bottom cone-shaped portion, is included, wherein the top planar portion further comprises a mounting member extending upwardly from the top planar portion. The mounting member is adapted to operably couple the suction cup base to the bottom side of the toy item at the aperture and cavity disposed on the bottom side of the toy item. The cone-shaped portion of the suction cup base is adapted to operably couple the retaining device to a smooth planar surface using a vacuum suction engagement with the planar surface. A channel is disposed about the mounting member of the suction cup base. A retaining bar having a clip portion and a receiving portion, is rotatably received in the channel of the mounting member at the clip portion of the retaining bar. One or more tethering straps having proximal ends and distal ends are coupled to the retaining bar. Specifically, the proximal ends are operably coupled to the receiving portion of the retaining bar and the distal ends comprise a clip assembly adapted to couple to various childcare items.

Another aspect of the present invention includes a retaining device for tethering to various childcare items comprising a toy mounting assembly including a toy item having a front side, a back side, a top side and a bottom side, wherein an aperture opens into a threaded cavity disposed on the bottom side of the toy item. A suction cup base includes a top planar portion and a bottom cone-shaped portion, wherein the top planar portion further comprises a mounting member having a threaded fastener extending upwardly from and partially embedded in an upper portion of the mounting member. The fastener is adapted to operably couple the suction cup base to the bottom side of the toy item at the threaded cavity disposed in an interior of the toy item. The cone-shaped portion of the suction cup base is adapted to operably couple to a variety of planar surfaces, such as a table top, high chair tray or other like surface, using a vacuum suction engagement with the planar surface. A retaining bar is disposed between the suction cup base and the toy item, and includes a clip portion and a receiving portion, wherein the clip portion is rotatably coupled to either the fastener or the mounting member of the suction cup base. A plurality of tethering straps, each having a proximal end and distal end, are operably coupled to the retaining bar. The proximal ends of the tethering straps are releaseably coupled to the receiving portion of the retaining bar and the distal ends comprise a clip assembly adapted to releaseably couple to various childcare items.

These and other features, objects and advantages of the present invention will be further understood and appreciated by those skilled in the art upon studying the following specification and appended drawings.

### BRIEF DESCRIPTION OF THE DRAWINGS

FIG. 1 is a fragmentary perspective view of a retaining device embodying the present invention;

FIG. 2 is a perspective view of another embodiment of the present invention;

FIGS. 3-4 are perspective views of a suction cup base;

FIG. 5 is a side elevational view of the suction cup base shown in FIG. 3;

FIGS. 6-7 are perspective views of a retaining bar;

FIGS. 8-10 are side elevational views of a toy mounting assembly;

FIG. 11 is a front elevational view of the toy mounting assembly of FIG. 8;

FIGS. 12 is a perspective view of the toy mounting assembly of FIG. 8;

FIGS. 13 and 13A are top plan views of the toy mounting assembly of FIG. 8;

FIG. 14 is a fragmentary perspective view of a clip assembly; and

FIG. 15 is a fragmentary top plan view of a clip assembly.

### DETAILED DESCRIPTION OF THE PREFERRED EMBODIMENT

For the purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in following specification, are simply exemplary embodiments. Hence, specific dimensions and other physical characteristics relating to the embodiments disclosed herein are not to be construed as limiting, unless expressly stated otherwise.

Referring to FIG. 1, the reference numeral 2 generally designates a retaining or retention device for tethering a childcare item to a surface. The retaining device 2 of the present invention generally includes a toy mounting assembly 10 having a suction cup base portion 12. As shown in FIG. 1, the retaining device 2 is mounted to a planar tabletop surface 20. In this embodiment, the toy mounting assembly 10 includes a toy 30 mounted to the suction cup base portion 12 as further described below. The toy 30 is comprised of a molded polymeric structure which, in this embodiment, is in the shape of the head of a giraffe. While this embodiment depicts the head of a giraffe, other toy items, such as stuffed animal toys and the like, can be used with the present invention without detracting from the spirit of the invention. The toy item 30 is provided to make the actual overall retaining device 2 itself more attractive and interesting for an infant or toddler.

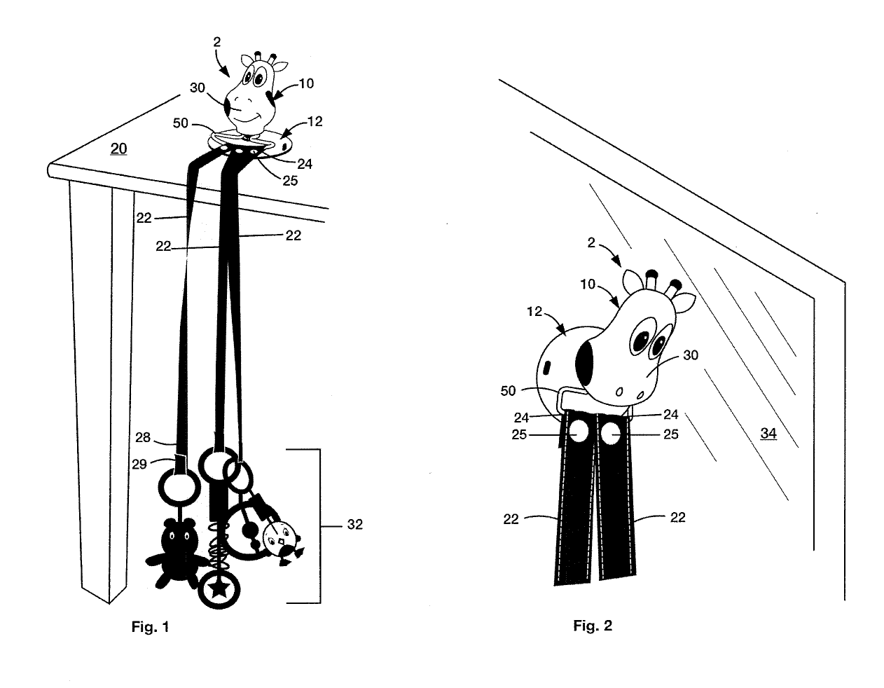

As further shown in FIG. 1, adjustable tethering straps 22 are attached to the toy mounting assembly 10 as further described below. It is contemplated that the plurality of adjustable tethering straps 22 can be made up of a soft nylon material which mounts to the suction cup base portion 12 directly under the giraffe toy item 30 at a rotating retaining bar 50; the functionality of which is described below. While this embodiment contemplates a nylon type material for use as the tethering straps, other materials are also contemplated including, but not limited to, elastic material, ruffled material, standard cloth material, polymeric and foam materials. The tethering straps 22 further comprise proximal ends 24 having fastening mechanisms or clip portions 25 for attaching the tethering straps 22 to the retaining bar 50, and further comprise distal ends 28 also having fastening mechanisms or clip portions 29 which are used to tether a toy, or other suitable childcare item, to the toy mounting assembly 10. The childcare items are indicated collectively in FIG. 1 as reference numeral 32. The plurality of adjustable tethering straps 22 can use the clip portions 29 disposed at the distal ends 28 of the tethering straps 22 to connect the toy mounting assembly to various items such as infant/toddler play items and toys, and care items such as pacifiers, feeding items, baby clothes, etc. In this way, the toy mounting assembly 10 provides a secure mounting to a planar tabletop surface 20 and allows for the toys or childcare items 32 to be attached to the tethering straps 22 in such a way that the toys or childcare items 32 will not touch a floor surface if they are dropped by the user. The straps 22 being adjustable, the user can adjust the length of the straps 22 to accommodate various heights of different planar surfaces to which the toy mounting assembly will adhere. Referring now to FIG. 2, the retaining device 2 is shown mounted to a planar glass surface 34 with tethering straps lying directly below the toy mounting assembly 10.

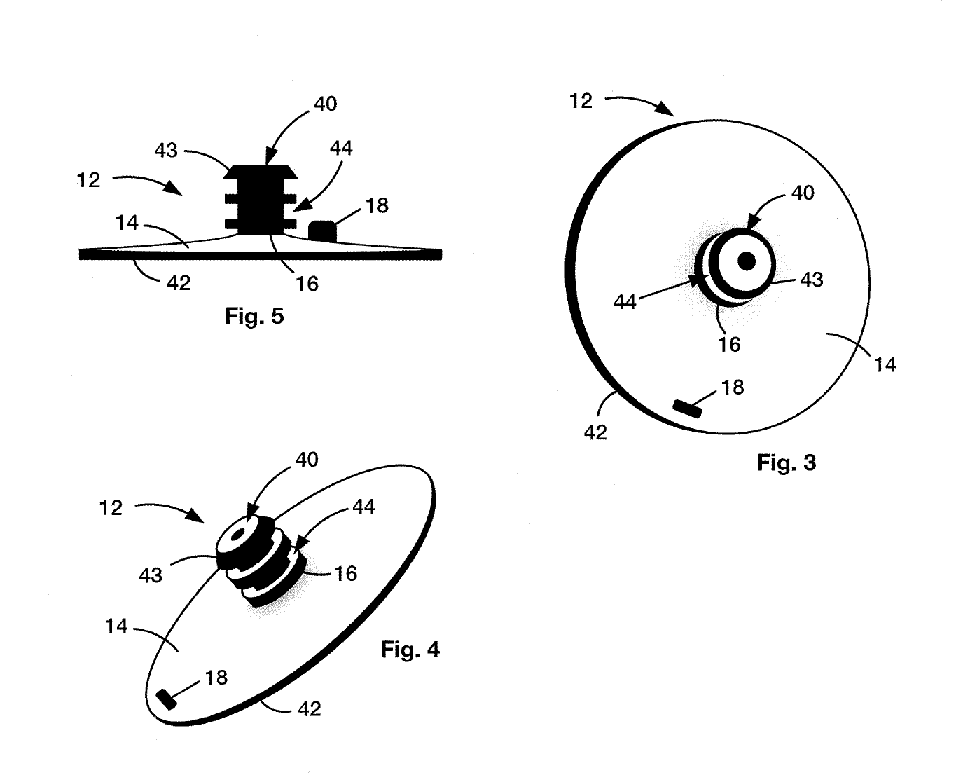

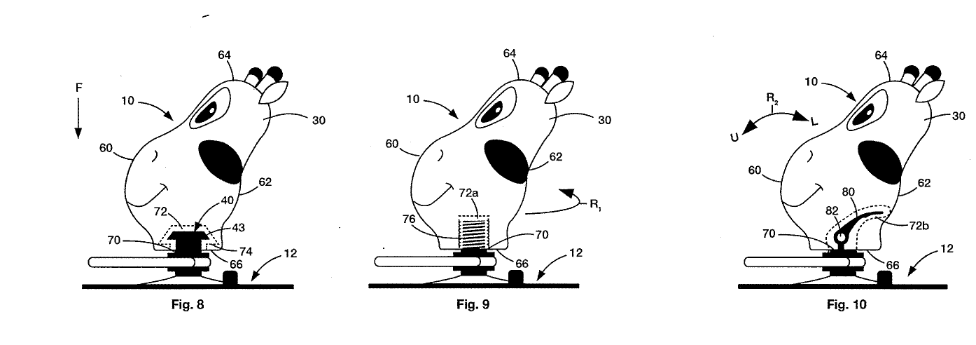

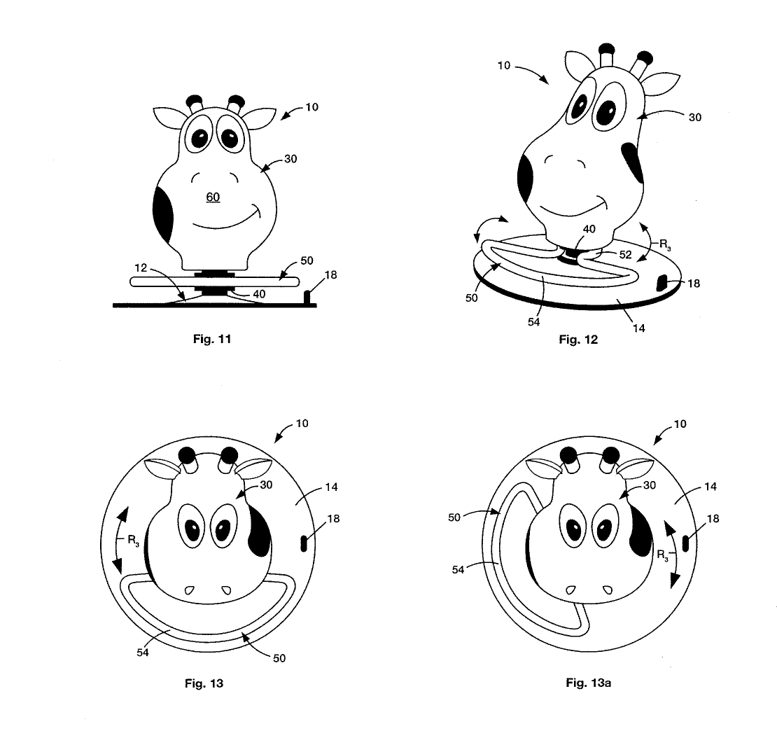

As shown in FIGS. 3-5, the suction cup base 12 is shown having a bottom cone-shaped suction cup portion 14 and a planar top portion 16 on which a mounting flange or mounting member 40 is disposed. As shown in the embodiment depicted in FIGS. 3-5, the mounting member 40 of the suction cup base 12 is a cylindrical mounting member comprising a securing member 43 disposed at an upper end of the mounting member 40, and a channel 44 disposed about a circumference of the mounting member 40. In assembly, the mounting member is used to couple the suction cup base 12 to the toy item 30 as shown in FIGS. 8-10 and further described below.

As shown in FIGS. 3-5, the suction cup base 12 further comprises a pull tab member 18 which is used to release the suction cup base 12 from a planar surface, such as the tabletop surface 20 shown in FIG. 1. The pull tab member 18 provides a place for the user to grasp the cone-shaped suction cup portion 14 near a lip portion 42 of the suction cup base 12, such that the user can break the suction or vacuum-type bond formed between the suction cup base 12 and a planar surface such as the tabletop surface 20 of FIG. 1. Once that bond is broken by pulling on the tab member 18, the toy mounting assembly 10 can be easily removed from the planar surface.

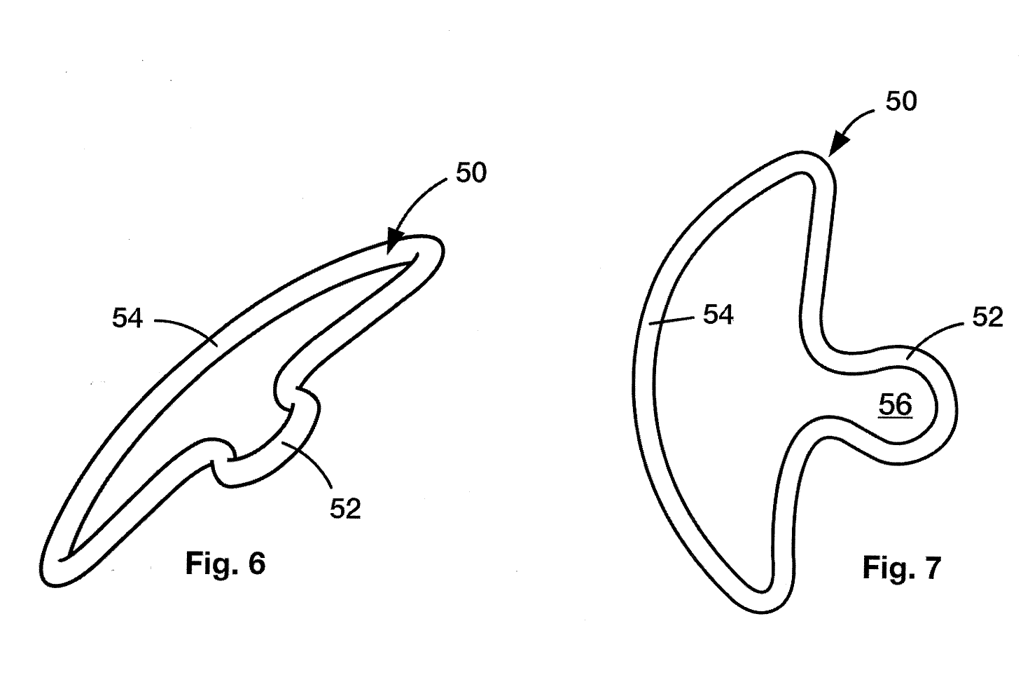

As shown in FIGS. 6-7, a retaining bar assembly 50 comprises a clip portion 52 and a receiving portion 54. The retaining bar assembly 50 is shown in FIGS. 6 and 7 as a continuous one-piece bar wherein the clip portion 52 and the receiving portion 54 comprise an arcuate outer configuration. Other configurations for the clip portion and receiving portion will be appreciated by those skilled in the art. The clip portion 52 of the retaining bar assembly 50 is configured to be received in the channel 44 of the mounting member 40 of the suction cup base 12 in assembly. The clip portion 52, shown in FIG. 7 defines a mounting member engagement area 56 where the mounting member 44 of the suction cup base 12 is located in assembly as best shown in FIGS. 8-10.

Referring now to FIGS. 8-10, the toy mounting apparatus 10 is shown having a toy item 30 coupled to a suction cup base 12, wherein the toy item 30 includes a front side 60, a back side 62, a top side 64 and a bottom side 66. The bottom side 66 is shown as a generally planar side having an aperture 70 disposed thereon. In assembly, the aperture 70 engages the mounting member 40 of the suction cup base 12. Specifically, with respect to FIG. 8, aperture 70 opens into a cavity 72 disposed within an interior of the toy item 30, wherein the cavity 72 further includes a beaded portion or lip 74 for engaging the securing member 43 disposed on the mounting member 40. The interaction between the lip 74 and the securing member 43 positively retains the toy item 30 on the mounting member 40 in a snap-fit engagement when the toy item 30 is pressed downwardly on the mounting member with a downward force indicated by arrow F in FIG. 8. Once attached to the suction cup base 12, the toy item 30 can be used to initiate engagement of the suction cup base 12 to a planar surface by pressing downwardly on the toy item 30 in the direction indicated by arrow F, which causes a deformation of the cone-shaped suction cup portion 14 of the suction cup base 12 thereby expelling air disposed therein to further cause a vacuum engagement of the suction cup base 12 with a planar surface.

As shown in FIG. 9, aperture 70 opens into a threaded cavity 72a disposed within an interior of the toy item 30 which threadingly engages a threaded fastener 76 extending upwardly from and partially embedded in the mounting member 40. The threaded fastener 76 is adapted to operably couple the suction cup base 12 to the bottom side 66 of the toy item 30, by rotating the toy item 30 in a direction indicated by arrow R₁ to screw the toy item into engagement with the mounting member 40 of the suction cup base. Further, the fastener 76 can be used to mount the tethering straps 22 directly thereto when a rotating retaining bar is not needed.

As shown in FIG. 10, aperture 70 opens into a cavity 72b disposed within an interior of the toy item 30 which engages a lever 80 extending upwardly from and operably coupled to the mounting member 40. The lever or actuator 80 is disposed on the top surface of the mounting member 40, and the lever 80 is hinged at hinge point 82 such that, in setting the suction cup base 12 on a planar surface, the lever 80 can be actuated by moving the toy item 30 between an unlocked position U to a locked position L along a rotational path indicated by the arrow R₂. Movement of the toy item 30 form the unlocked position U to the locked position L will deform the cone-shaped portion 14 of the suction cup base 12, such that, as the lever 80 is actuated, the lever 80 will increase the suction power of the suction cup base 12 on a planar surface by dispelling air captured in the suction cup cone-shaped portion 14 to form a vacuum engagement between the suction cup base 12 and a planar surface.

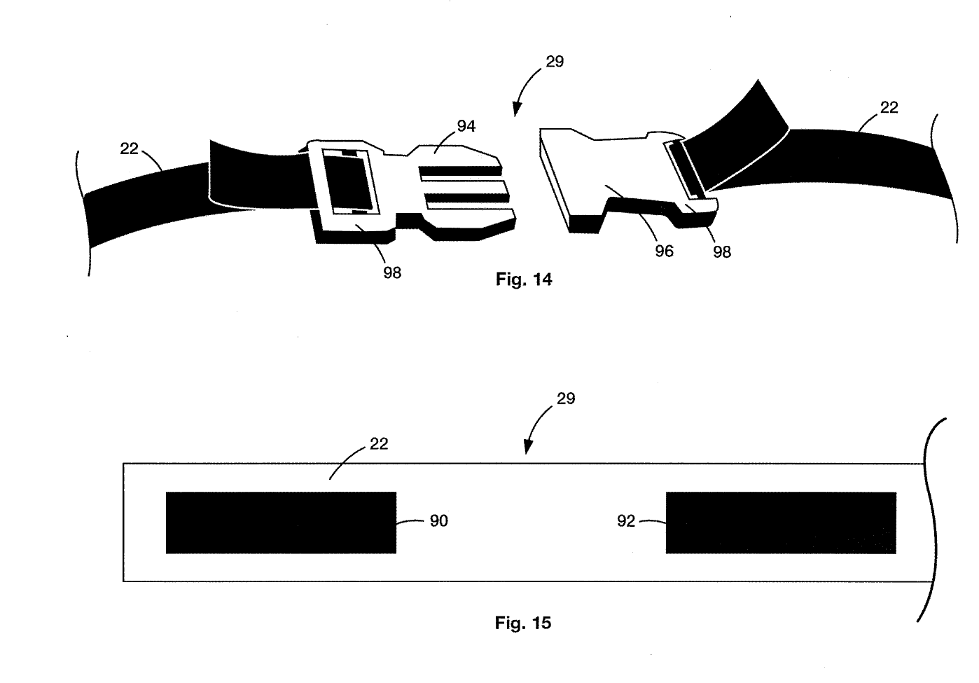

Referring now to FIGS. 14 and 15, embodiments of clip portions 29 are shown. While FIGS. 14 and 15 indicate that the clipping mechanisms are clip portions 29 dispersed at the distal ends 28 of the tethering straps 22, the same embodiments can be used at clip portions 25, also disposed on the tethering straps 22 at the proximal ends 24. As shown in FIG. 15, an embodiment of a clip portion 29 of a tethering strap 22 comprises a Velcro®-type clip which is integrated into the tethering strap 22. In this embodiment, the Velcro® clip portion 29 comprises a male Velcro® strip 90 and a female Velcro® portion 92. Essentially, the male portion 90 comprises rough Velcro® polymeric hooks and the female portion 92 comprises a soft Velcro® strip to which the male portion 90 adheres. In this way, the clip portion can fasten to a childcare item, such as items 32 in FIG. 1, or to the retaining bar 50 as shown in FIG. 1. With reference to FIG. 14, the clip portion 29 can also be a fastener having a male fastening portion 94 and a female fastening portion 96. While the embodiments shown in FIGS. 14 and 15 exemplify specific fastening mechanisms disposed on the tethering straps, any number of fastening mechanisms known in the art can be used with the present invention, such as button fasteners shown in FIGS. 1 and 2.

The tethering straps 22, as shown in FIG. 1 and described above, can be adjustable in length by strap adjustment means known in the art. As shown in FIG. 14, a length adjusting mechanism 98 can be incorporated into the clip portions 25 or 29 disposed on the tethering straps 22 at either the distal end 29 or the proximal end 24 of the tethering straps 22. The user of the toy mounting assembly can adjust the length of the straps to an appropriate level to ensure that the toys attached thereto will not hit the floor when the toy mounting assembly is mounted to any given planar surface. In this way, the toy mounting assembly of the present invention can be used on a multitude of surfaces at a multitude of varying surface heights. Further, the toy mounting assembly of the present invention has a removable toy item, such as toy item 30 shown in FIG. 1, mounted to the suction cup base, such that the toy item can be exchanged for other toy items, thereby offering a variety of interchangeable toy items to the user. The present invention also contemplates fixed tethering straps which are interchangeable with other fixed tethering straps of varying lengths.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired embodiment and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

1. A retaining device for tethering a childcare item comprising:
a toy mounting assembly including a toy item having front side, back side, top side and bottom side, an aperture disposed on the bottom side of the toy item opening into a cavity disposed in an interior of the toy item;
a suction cup base having a top planar portion and a bottom cone-shaped portion, wherein the top planar portion further comprises a mounting member extending upwardly therefrom, and further wherein the mounting member is adapted to operably couple the suction cup base to the bottom side of the toy item at the aperture disposed on the bottom side of the toy item, and further wherein the cone-shaped portion is adapted to operably couple to a planar surface;
a channel disposed about the mounting member;
a retaining bar including a clip portion and a receiving portion, wherein the clip portion is adapted to be received in the channel of the mounting member; and
a tethering strap having a proximal end and distal end, wherein the proximal end is operably coupled to the receiving portion of the retaining bar and the distal end comprises a clip assembly adapted to couple to the childcare item.

2. The retaining device of claim 1, wherein:
the mounting member of the suction cup base and the aperture disposed on the bottom side of the toy item are cylindrical.

3. The retaining device of claim 2, wherein:
the channel disposed about the mounting member is fully disposed around a circumference of the mounting member.

4. The retaining device of claim 3, wherein:
the retaining bar is a continuous one-piece bar with an arcuate shaped clip portion and an arcuate shaped receiving portion.

5. The retaining device of claim 4, wherein:
the arcuate clip portion of the retaining bar is frictionally received and retained in the channel of the mounting member such that the retaining bar is rotatable about the mounting member to a plurality of positions along the circumference of the mounting member.

6. The retaining device of claim 1, further comprising:
a tab member disposed on an upper surface of the bottom cone-shaped portion of the suction cup base, wherein the tab member is adapted to facilitate the release of the suction cup base when the suction cup based is engaged with the planar surface.

7. The retaining device of claim 1, wherein:
the tethering strap is adjustable in length.

8. The retaining device of claim 7, wherein:
the clip assembly disposed on the distal end of the tethering strap comprises a Velcro clip assembly.

9. The retaining device of claim 7, wherein:
the clip assembly disposed on the distal end of the tethering strap comprises an adjustable male and female clip assembly.

10. The retaining device of claim 1, wherein:
the toy item is adapted to actuate an adherence of the suction cup base to the planar surface when a downward force is realized on the toy item.

11. The retaining device of claim 3, further comprising:
a lip disposed along a circumference of the cavity of the toy item; and
a securing member disposed about the circumference of the mounting member above and adjacent to the channel of the mounting member, wherein the securing member is adapted to engage the lip in the cavity of the toy item in a snap-fit engagement.

12. The retaining device of claim 1, further comprising:
a plurality of tethering straps which are adjustable in length.

13. A retaining device for tethering a childcare item comprising:
a toy mounting assembly including a toy item having a front side, a back side, a top side and a bottom side;
an aperture disposed on the bottom side of the toy item, wherein the aperture opens into a threaded cavity;
a suction cup base having a top planar portion and a bottom cone-shaped portion, wherein the top planar portion further comprises a mounting member having a threaded fastener extending upwardly therefrom, and further wherein the threaded fastener is adapted to operably couple the suction cup base to the bottom side of the toy item at the threaded cavity of the toy item, and further wherein the cone-shaped portion is adapted to operably couple the retaining device to a planar surface;
a retaining bar disposed between the suction cup base and the toy item, wherein the retaining bar includes a clip portion and a receiving portion, wherein the clip portion is rotatably coupled to one of either the fastener or the mounting member; and
a plurality of tethering straps, each having a proximal end and distal end, wherein the proximal end is operably releaseably coupled to the receiving portion of the retaining bar and the distal end comprises a clip assembly adapted to releaseably couple to the childcare item.

14. The retaining device of claim 13, wherein:
the plurality of tethering straps are each adjustable in length and adapted to retain the childcare item above a floor surface.

15. The retaining device of claim 14, further comprising:
a clip assembly disposed on the proximal end of each of the tethering straps for coupling the straps to the receiving portion of the retaining bar, wherein the clip assembly is selected from the group comprising a velcor assembly, a male and female clip assembly, and a button assembly.

16. The retaining device of claim 14, wherein:
the retaining bar is a continuous one-piece bar with an arcuate shaped clip portion and an arcuate shaped receiving portion.

17. The retaining device of claim 14, further comprising:
a tab member disposed on an upper surface of the bottom cone-shaped portion of the suction cup base, wherein the tab member is adapted to facilitate the release of the suction cup base when the suction cup based is engaged with the planar surface.

18. The retaining device of claim 17, wherein:
the clip assembly disposed on the distal end of each of the tethering straps comprises a Velcro clip assembly.

19. The retaining device of claim 17, wherein:
the clip assembly disposed on the distal end of each of the tethering straps comprises an adjustable male and female clip assembly.
